(19) United States
(12) Patent Application Publication
(10) Pub. No.: US 2018/0137403 A1
(43) Pub. Date: May 17, 2018

(54) SENSOR DATA

(71) Applicant: Hewlett Packard Enterprise Development LP, Houston, TX (US)

(72) Inventors: Satwant Kaur, San Jose, CA (US); Shoumen Bardhan, Tulsa, OK (US); Charlie Bess, Frisco, TX (US); Corey Wick, Plano, TX (US)

(21) Appl. No.: 15/574,179

(22) PCT Filed: May 15, 2015
(86) PCT No.: PCT/US2015/031212

§ 371 Date: Nov. 15, 2017

(51) Int. Cl. G06N 3/02

(52) U.S. Cl. CPC G06N 3/02

(57) ABSTRACT

Examples disclosed herein relate, among other things, to a non-transitory machine-readable storage medium encoded with instructions executable by a processor of a computing device to cause the computing device to obtain data from a plurality of sensors of at least a first type and a second type. The instructions may also cause the computing device to determine, for each sensor of the second type, whether the data obtained from the sensor of the second type is reliable based at least on the data obtained from a sensor of the first type that is associated with the sensor of the second type.

### BACKGROUND

Today's widespread availability of wireless networking creates an unprecedented opportunity to collect data from sensors and other devices in almost any environment or location. To date, however, the expense of quality, reliable sensors for data collection restricts actual use to well-funded, resource intensive applications. And while low cost sensors exist, they are very sensitive to inaccuracy caused by time, heat, pressure, moisture, temperature, and a variety of other factors.

### BRIEF DESCRIPTION OF THE DRAWINGS

The following detailed description references the drawings, wherein:

FIG. 1 is a block diagram of an example system;

FIG. 2 is another block diagram of an example computing system;

FIG. 3 shows a flowchart of an example method; and

FIG. 4 is a block diagram of an example computing device.

### DETAILED DESCRIPTION

As mentioned above, including many high-quality sensors in a network of sensors may be too expensive or technologically complicated. Lower quality sensors may be cheaper and/or easier to integrate into a sensor network, but may produce inaccurate and unreliable data. Examples provided herein discuss, among other things, a system that includes a plurality of sensors varying in terms of price, quality (i.e., accuracy), type, complexity, configuration, and other parameters.

Some examples discussed herein discuss a system that includes, among other things, a first sensor, a second set of sensors, a third set of sensors, and a computing device. The computing device may obtain data from the first sensor, the second set of sensors, and the third set of sensors, determine reliability of the data obtained from the second set of sensors based on the data obtained from the first sensor, and determine reliability of the data obtained from the third set of sensors based on the data obtained from the second set of sensors.

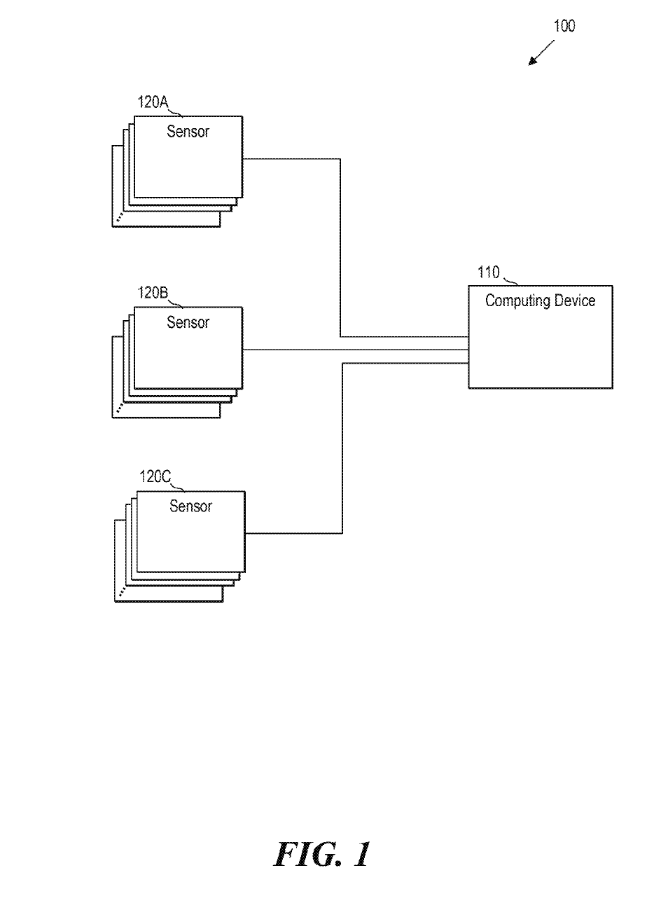

FIG. 1 is a block diagram of an example computing system 100. System 100 may include a computing device 110, a first set of sensors 120A, a second set of sensors 120B, and a third set of sensors 120C. Computing device 210 may include one or more electronic devices, where an “electronic device” may include, for example, a network server, a desktop computer, a laptop computer, a tablet computer, a smartphone, or any other type of electronic device. In some examples, computing device 110 may include one or more engines for implementing the functionality discussed below, where the engine(s) may be hardware engines or may be implemented as any combination of hardware and programming. In some examples, some or all of the modules of computing device 110 may be embedded in one or more sensors from one or more sets 120A, 120B, and 1200. Computing device 110 may include a memory, which may be a non-transitory memory, and which may include any combination of volatile and non-volatile memory. The memory may include, for example, combination of random-access memories (RAMS), flash memories, hard drives, memristor-based memories, and the like.

Each set of sensors 120A, 120B, and 120C may include one or more sensors. As used herein, a “sensor” may refer to any type of electronic device capable of sensing (i.e., detecting) one or more characteristics of its environment and provide one or more output representing the characteristic(s). For example, a sensor may sense light, motion, temperature, electromagnetic fields, gravity, humidity, moisture, vibration, pressure, sound, or any other physical aspects of the external environment. In some examples, the sensor's output may include analog or digital data that represents the value(s) of the sensed characteristic(s). The sensor data may be transmitted by the sensor to other devices such as computing device 110, for example, through a direct wired or wireless connection, and/or through one or more networks. The network may include one or more local-area networks and wide-area networks (e.g., the Internet) that may be implemented using any type of wired or wireless technologies such as Ethernet, Wi-Fi, cellular communication, satellite communication, etc.

In some examples, all sensors in sets 120A, 120B, and 120C may be capable of sensing and measuring at least one common characteristic of the environment (e.g., temperature). However, in some examples, first set of sensors 120A may include one or more sensors that are more accurate than the one or more sensors in second set of sensors 120B. In addition, in some examples, second set of sensors 120B may include one or more sensors that are more accurate than the one or more sensors in third set of sensors 1200. For example, each sensor in first set of sensors 120A may be a sensor of a first type, each sensor in second set of sensors 120B may be a sensor of a second type, and each sensor in third set of sensors 1200 may be a sensor of a third type, where the first type is characterized by a higher accuracy than the second type and the second type is characterized by a higher accuracy than the third type. “Higher accuracy” as used herein may mean, for example, that a sensor has a higher signal-to-noise ratio, a higher signal resolution, a higher tolerance to harsh environment conditions and to time of operation, or any combination of these or other parameters. Thus, sensors in sets 120A, 120B, and 120C may measure the same characteristic (e.g., temperature) but with different decrees of accuracy. As discussed above, in some examples, a sensor characterized by higher accuracy may also be characterized by higher cost and/or complexity.

As discussed above, some sensors (e.g., all sensors of second sensor set 120B) may be sensors of a particular sensor type (e.g., the second sensor type). In some examples, the particular sensor type may be associated with a correction model. The correction model may include a correction function (e.g., a polynomial function) that may be used to correct output data of any sensor belonging to the particular sensor type. The correction model may be generated, for example, by placing one or more sensors from the particular sensor type in a controlled environment, and feeding the outputs of those sensors, along with at least one reliable reference data (e.g., from a more accurate sensors located in the same controlled environment), to a computing device. The computing device may then apply various techniques, such as machine learning techniques, to determine the correction model based on the outputs and the reference data. For example, the outputs and the reference data may be fed into an artificial neural network (ANN) that may apply statistical learning algorithms to estimate or approximate a correction function. In some examples, data obtained from sensors belonging to a sensor type associated with a correction model may be corrected with the correction model, either by the sensors themselves or by computing device 110. Thus, in some examples, the correction model (e.g., the polynomial coefficients) may be obtained by the sensors (e.g., from their internal memory) and/or by computing device 110.

In some examples, the number of sensors in first sensor set 120A may be smaller than the number of sensors in second sensor set 1206, which in turn may be smaller than the number of sensors in third sensor set 1200. In some examples, a sensor may be spatially associated with one or more sensors from the same set and/or from different set(s). For example, a plurality of sensors from second sensor set 120B may be spatially associated with one sensor from first sensor set 120A, and one or more sensors from third sensor set 1200 may be spatially associated with at least one sensor from second sensor set 120A. Being “spatially associated” as used herein may mean, for example, that the sensors are located (e.g., physically disposed) within a predefined distance (e.g., 100 feet) from each other. For example, some sensor(s) in second sensor set 1206 may be located within a first predefined distance from a particular sensor in first sensor set 120A, and some sensor(s) in third sensor set 120C may be located within a second predefined distance from a particular sensor in second sensor set 1206, where the first predefined distance may be longer, shorter, or substantially equal to the second predefined distance.

In some examples, all sensors within a particular set (e.g., second sensor set 1206) may be located equidistantly from each other. In some examples, computing device 110 may be able to obtain the absolute or the relative locations of some or all sensors in some or all sensor sets. For example, the locations may be specified by a system administrator, provided to computing device 110 (e.g., wirelessly) by sensors equipped with global positioning system (GPS) modules, or otherwise determined, e.g., using triangulation techniques.

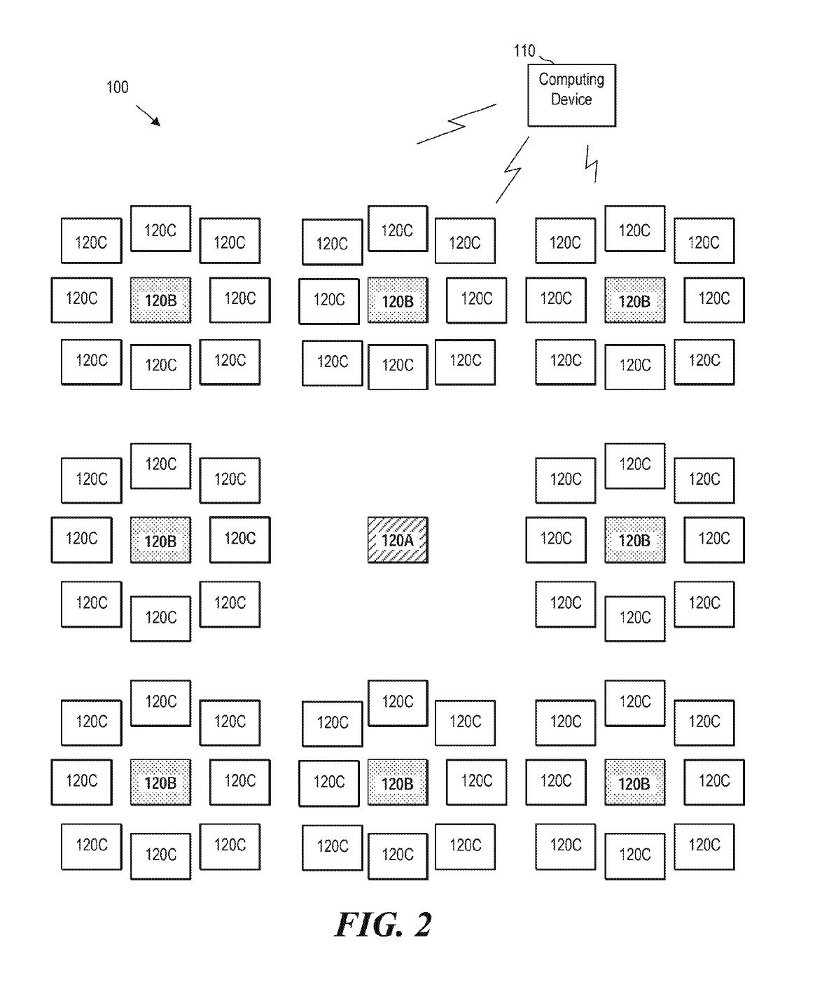

For example, FIG. 2 illustrates an example in which eight sensors from second sensor set 120B (also referred to as “sensors 120B”) are located substantially equidistantly and within a first predefined distance from one sensor from first sensor set 120A (also referred to herein as “sensor 120A” or “the first sensor”). In addition, each sensor 120B in the example of FIG. 2 is located within a second predefined distance (and in this example, at substantially the same radial distance) from eight sensors from third sensor set 1200 (also referred to as “sensors 120C”).

Referring to FIG. 2 in conjunction with FIG. 1, in some examples, computing device 110 may obtain data from the sensor 120A, sensors 120B, and sensors 120C. As discussed above, the sensors may transmit their output data to computing device 110 via any type of wired or wireless means.

After obtaining the data, computing device 110 may determine, based on the data obtained from the first sensor, the reliability of the data obtained from sensors 120B. As used herein “unreliable data” may refer to data that originating from a sensor that has (or likely has) deteriorated to an unacceptable level due to a long operational time, harsh environmental conditions, faulty constructions, or other causes. To determine reliability of the data, computing device 110 may, for example, compare data obtained from each sensor 120B to data obtained from sensor 120A, and determine whether the data obtained from any sensor 120B is not within a predefined range from the data obtained from sensor 120A. The predefined range may be, for example, a fixed predefined percentage (e.g., 20%), a fixed predefined absolute amount (e.g., 1° C.), or a range that varies depending on any of the two compared data.

More generally, in some examples, computing device 110 may use a reliability function to determine whether any data from obtained from sensors 120B is reliable or unreliable. The reliability function may be a function of the data obtained from sensor 120A and the data obtained from a particular sensor 120B. In some examples, the function may be also a function of other factors. The other factors may include, for example, a distance between the particular sensor 120B and sensor 120A, where longer distances may allow for larger discrepancies between the data. The reliability function may also consider data obtained from one or more other sensors 120A (not shown in FIG. 2 for brevity), one or more other sensors 120B, and/or one or more other sensors 120C. In some examples, the reliability function may only consider data obtained from sensors within the vicinity of (e.g., within a predefined distance from) the particular sensor 120B. In some examples, the function may also consider the distance between the particular sensor 120B and the other sensors whose data is considered. For example, the reliability function may compare the data obtained from the particular sensor 120B to a weighted average (or another function) of data obtained from one or more other sensors, where data obtained from sensors that are located closer to the particular sensor 120B may have more weight, and/or where data obtained from sensors of types associated with higher accuracy may have more weight.

If data obtained from any sensor 120B is determined by computing device 110 to be unreliable, computing device 110 may, for example, discard that data, adjust or modify that data using a modification formula that may reduce the discrepancy, mark the sensor 120B as unreliable, reset the sensor 120B, shut down the sensor 120B, reprogram the sensor 120B with new firmware or parameters, repair or replace the sensor 120B, or otherwise manipulate the data or the sensor 120E from which the data was obtained.

Similarly, in some examples, computing device 110 may also determine reliability of data obtained from any sensor 1200. For example, computing device 110 may compare data obtained from a particular sensor 120C to data obtained from sensor 120B closest to that particular sensor 120B. Alternatively or in addition, computing device 110 may compare data obtained from a particular sensor 120C to data obtained from one or more sensors of one or more types (e.g., 120A, 120B, or 120C). For example, computing device 110 may compare those data using a reliability function (similar to or different than the reliability function discussed above) to determine whether the data obtained from the particular sensor 1200 is reliable. If data obtained from any sensor 120C is determined by computing device 110 to be unreliable, computing device 110 may, for example, computing device 110 may, for example, discard that data, adjust or modify that data using a modification formula that may reduce the discrepancy, mark the sensor 1200 as unreliable, reset the sensor 1200, shut down the sensor 1200, reprogram the sensor 1200 with new firmware or parameters, replace the sensor 120C, or otherwise manipulate the data or the sensor 1200 from which the data was obtained.

It is appreciated that the examples discussed herein are not limiting, and that the functionality discussed herein may also be applicable that system 100 may include, for example, only sensors of two types characterized by different degrees of accuracy (e.g., only sensors 120A and 120B, only sensors 120B and 1200, or only sensors 120A and 120C). Further, in some examples, system 100 may include sensors of more than three types, such as sensors of more than three levels of accuracy.

As discussed above, in some examples, computing device 110 may implement the functionality discussed herein using one or more engines, each of which may be implemented as any combination of hardware and programming. For example, the programming may include processor-executable instructions stored on a tangible, non-transitory computer-readable medium, and the hardware may include a processing resource for executing those instructions. The processing resource, for example, may include one or multiple processors (e.g., central processing units (CPUs), semiconductor-based microprocessors, graphics processing units (GPUs), field-programmable gate arrays (FPGAs) configured to retrieve and execute instructions, or other electronic circuitry), which may be integrated in a single device or distributed across devices. The computer-readable medium can be said to store program instructions that when executed by the processor resource implement the functionality of the respective component. The computer-readable medium may be integrated in the same device as the processor resource or it may be separate but accessible to that device and the processor resource. In one example, the program instructions can be part of an installation package that when installed can be executed by the processor resource to implement the corresponding component. In this case, the computer-readable medium may be a portable medium such as a CD, DVD, or flash drive or a memory maintained by a server from which the installation package can be downloaded and installed. In another example, the program instructions may be part of an application or applications already installed, and the computer-readable medium may include integrated memory such as a hard drive, solid state drive, or the like. In another example, the engines may be implemented by hardware logic in the form of electronic circuitry, such as application specific integrated circuits.

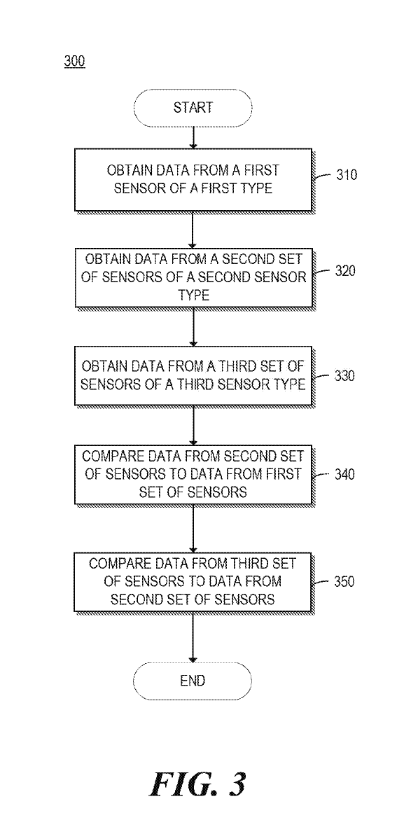

FIG. 3 is a flowchart of an example method 300 for determining data reliability. Method 300 may be described below as being executed or performed by a system or by one or more devices such as computing device 110. Other suitable systems and/or computing devices may be used as well. Method 300 may be implemented in the form of executable instructions stored on at least one non-transitory machine-readable storage medium of the system and executed by at least one processor of the system. Alternatively or in addition, method 300 may be implemented in the form of electronic circuitry (e.g., hardware). In alternate examples of the present disclosure, one or more blocks of method 300 may be executed substantially concurrently or in a different order than shown in FIG. 3. In alternate examples of the present disclosure, method 300 may include more or less blocks than are shown in FIG. 3. In some examples, one or more of the blocks of method 300 may, at certain times, be ongoing and/or may repeat.

At block 310, the method may obtain data from a first sensor of a first sensor type. At block 320, the method may obtain data from a second set of sensors of a second sensor type, where the second set of sensors are disposed within a first predefined distance from the first sensor, and where the first sensor type is characterized by higher accuracy than the second sensor type. At block 330, the method may obtain data from a third set of sensors of a third sensor type, where each of the third set of sensors is disposed within a second predefined distance from at least one of the second set of sensors, and where the second sensor type is characterized by higher accuracy than the third sensor type. As discussed above, in some examples, the data from the various sensors may be obtained wirelessly.

At block 340, the method may compare the data obtained from at least one of the second set of sensors to the data obtained from the first sensor to determine whether the data obtained from the at least one of the second set of sensors is reliable. At block 350, the method may compare the data obtained from at least one of the third set of sensors to the data obtained from at least one of the second set of sensors to determine whether the data obtained from the at least one of the third set of sensors is reliable.

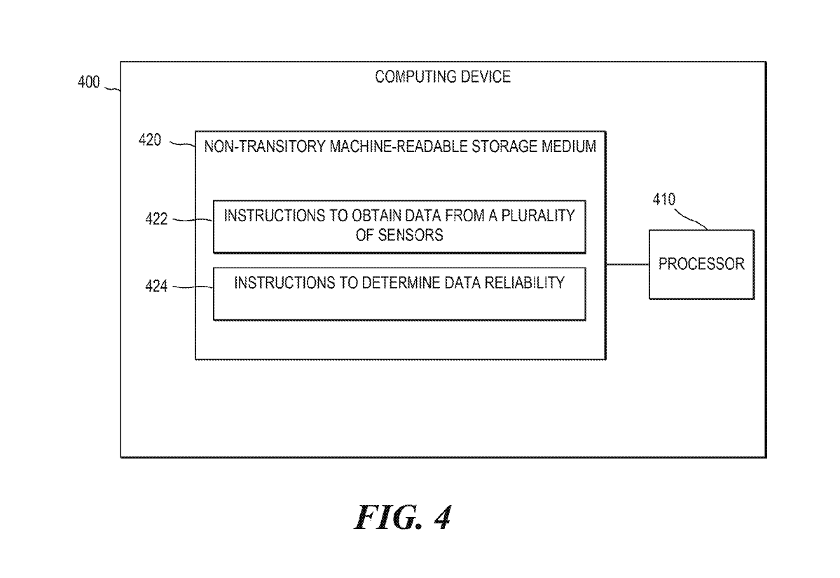

FIG. 4 is a block diagram of an example computing device 400. Computing device 400 may be similar to computing device 110 of FIG. 1. In the example of FIG. 4, computing device 400 includes a processor 410 and a non-transitory machine-readable storage medium 420. Although the following descriptions refer to a single processor and a single machine-readable storage medium, it is appreciated that multiple processors and multiple machine-readable storage mediums may be anticipated in other examples. In such other examples, the instructions may be distributed (e.g., stored) across multiple machine-readable storage mediums and the instructions may be distributed (e.g., executed by) across multiple processors.

Processor 410 may be one or more central processing units (CPUs), microprocessors, and/or other hardware devices suitable for retrieval and execution of instructions stored in non-transitory machine-readable storage medium 420. In the particular example shown in FIG. 4, processor 410 may fetch, decode, and execute instructions 472, 424, or any other instructions not shown for brevity. As an alternative or in addition to retrieving and executing instructions, processor 410 may include one or more electronic circuits comprising a number of electronic components for performing the functionality of one or more of the instructions in machine-readable storage medium 420. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Non-transitory machine-readable storage medium 420 may be any electronic, magnetic, optical, or other physical storage device that stores executable instructions. Thus, medium 420 may be, for example, Random Access Memory (RAM), an Electrically-Erasable Programmable Read-Only Memory (EEPROM), a storage drive, an optical disc, and the like. Medium 420 may be disposed within computing device 400, as shown in FIG. 4. In this situation, the executable instructions may be “installed” on computing device 400. Alternatively, medium 420 may be a portable, external or remote storage medium, for example, that allows computing device 400 to download the instructions from the portable/external/remote storage medium. In this situation, the executable instructions may be part of an “installation package.” As described herein, medium 420 may be encoded with executable instructions for finding a network device on a network.

Referring to FIG. 4, instructions 422, when executed by a processor, may cause a computing device to obtain (e.g., wirelessly) data from a plurality of sensors, where the plurality of sensors comprises sensors of at least a first type and a second type, and where each sensor of the second type is spatially associated with at least one sensor from the first type. Instructions 424, when executed by a processor, may cause the computing device to determine, for each sensor of the second type, whether the data obtained from the sensor of the second type is reliable based at least on the data obtained from a sensor of the first type associated with the sensor of the second type. If the data is determined to be unreliable, instructions 424 may cause the computing device to perform at least one of the following actions: discard the data, modify the data, reset the sensor of the second type, reprogram the sensor of the second type, or perform other manipulations of the data and/or the sensor of the second type.

As discussed above, determining whether the data obtained from the sensor of the second type is reliable may include determining whether the data obtained from the sensor of the second type is within a predefined range from the data obtained from a sensor of the first type associated with the sensor of the second type. As also discussed above, the determination of whether the data obtained from the sensor of the second type is reliable may be based at least on the data obtained from at least two sensors of the first type associated with the sensor of the second type. As further discussed above, the determination of whether the data obtained from the sensor of the second type is reliable may be further based on a distance between the sensor of the second type and the sensor of the first type associated with the sensor of the second type.

What is claimed is:

1. A computing device to:
obtain data from a first sensor, a second set of sensors, and a third set of sensors, wherein the first sensor is characterized by a higher accuracy than the second set of sensors, and wherein the second set of sensors are characterized by a higher accuracy than the third set of sensors;
determine reliability of the data obtained from the second set of sensors based on the data obtained from the first sensor; and
determine reliability of the data obtained from the third set of sensors based on the data obtained from the second set of sensors.

2. The computing device of claim 1, wherein determining the reliability of the data obtained from the second set of sensors comprises determining whether the data obtained from the second set of sensors is within a predefined range from the data obtained from the first sensor.

3. The computing device of claim 2, wherein each data obtained from the second set of sensors is corrected based on a correction model generated using a neural network.

4. The computing device of claim 1, wherein the computing device is further to:
discard any data obtained from the second set of sensors that were determined to be unreliable; and
discard any data obtained from the third set of sensors that were determined to be unreliable.

5. The computing device of claim 1, wherein the computing device is further to:
adjust, based on the data obtained from the first sensor, any data obtained from the second set of sensors that were determined to be unreliable; and
adjust, based on the data obtained from the second set of sensors, any data obtained from the third set of sensors that were determined to be unreliable.

6. The computing device of claim 1, wherein each of the third set of sensors is associated with a subset of sensors from the second set of sensors, and wherein determining reliability of the data obtained from the third set of sensors comprises comparing the data obtained from each sensor in the third set of sensors to the data obtained from the subset of sensors associated with the sensor.

7. The computing device of claim 1, wherein determining reliability of the data obtained from the second set of sensors comprises comparing a difference between each data obtained from the second set of sensor and the first data to a predefined range.

8. The computing device of claim 1, wherein the second set of sensors are disposed within a first predefined distance from the first sensor, and each of the third set of sensors is disposed within a second predefined distance from at least one of the second set of sensors.

9. A method comprising:
obtaining data from a first sensor of a first sensor type;
obtaining data from a second set of sensors of a second sensor type, wherein the second set of sensors are disposed within a first predefined distance from the first sensor, and wherein the first sensor type is characterized by higher accuracy than the second sensor type;
obtaining data from a third set of sensors of a third sensor type, wherein each of the third set of sensors is disposed within a second predefined distance from at least one of the second set of sensors, and wherein the second sensor type is characterized by higher accuracy than the third sensor type;
comparing the data obtained from at least one of the second set of sensors to the data obtained from the first sensor to determine whether the data obtained from the at least one of the second set of sensors is reliable; and
comparing the data obtained from at least one of the third set of sensors to the data obtained from at least one of the second set of sensors to determine whether the data obtained from the at least one of the third set of sensors is reliable.

10. The method of claim 9, wherein the second set of sensors are disposed substantially equidistantly from each other.

11. The method of claim 9, wherein the data obtained from the first sensor, the second set of sensors, and the third set of sensors are obtained wirelessly.

12. A non-transitory machine-readable storage medium encoded with instructions executable by a processor of a computing device to cause the computing device to:
obtain data from a plurality of sensors, wherein the plurality of sensors comprises sensors of at least a first type and a second type, and wherein each sensor of the second type is spatially associated with at least one sensor from the first type; and
for each sensor of the second type, determine whether the data obtained from the sensor of the second type is reliable based at least on the data obtained from a sensor of the first type associated with the sensor of the second type, and if the data is determined to be unreliable perform at least one of: discarding the data, modifying the data, resetting the sensor of the second type, and reprogramming the sensor of the second type.

13. The non-transitory machine-readable storage medium of claim 12, wherein determining whether the data obtained from the sensor of the second type is reliable comprises determining whether the data obtained from the sensor of the second type is within a predefined range from the data obtained from a sensor of the first type associated with the sensor of the second type.

14. The non-transitory machine-readable storage medium of claim 12, wherein the determination of whether the data obtained from the sensor of the second type is reliable is based at least on the data obtained from at least two sensors of the first type associated with the sensor of the second type.

15. The non-transitory machine-readable storage medium of claim 12, wherein the determination of whether the data obtained from the sensor of the second type is reliable is further based on a distance between the sensor of the second type and the sensor of the first type associated with the sensor of the second type.
